(19) United States
(12) Patent Application Publication
(10) Pub. No.: US 2026/0333253 A1
(43) Pub. Date: Oct. 22, 2026

(54) INITIAL CELL SEARCH AND DETERMINING A CELL IDENTIFIER

(71) Applicant: Lenovo (United States) Inc., Morrisville, NC (US)

(72) Inventors: Karthikeyan Ganesan, Nauheim (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/545,833

(22) Filed: Feb. 20, 2026

(51) Int. Cl. H04W 56/00

(52) U.S. Cl. CPC H04W 56/00

(57) ABSTRACT

Various aspects of the present disclosure relate to initial cell search and determining a cell identifier (ID). A user equipment (UE) receives a sequence indicating a presence of at least one synchronization signal block (SSB) in a first carrier frequency. The UE monitors for the at least one SSB in the first carrier frequency based on the sequence. The UE generates an ID associated with a network equipment (NE) based on a primary synchronization signal (PSS) and a secondary synchronization signal (SSS) of the at least one SSB.

### TECHNICAL FIELD

The present disclosure relates to wireless communications, and more specifically to initial cell search and determining a cell identifier (ID).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive a sequence indicating a presence of at least one synchronization signal block (SSB) in a first carrier frequency, monitor for the at least one SSB in the first carrier frequency based on the sequence, and generate an ID associated with an NE based on a primary synchronization signal (PSS) and a secondary synchronization signal (SSS) of the at least one SSB.

A processor (e.g., a standalone processor chipset, or a component of the UE) for wireless communication is described. The processor may be configured to, capable of, or operable to perform one or more operations as described herein. For example, the processor may be configured to, capable of, or operable to receive a sequence indicating a presence of at least one SSB in a first carrier frequency, monitor for the at least one SSB in the first carrier frequency based on the sequence, and generate an ID associated with an NE based on a PSS and an SSS of the at least one SSB.

A method performed or performable by a UE for wireless communication is described. The method may include receiving a sequence indicating a presence of at least one SSB in a first carrier frequency, monitoring for the at least one SSB in the first carrier frequency based on the sequence, and generating an ID associated with an NE based on a PSS and an SSS of the at least one SSB.

In some implementations, the UE, the processor, and the method may further be configured to, capable of, or operable to receive the sequence in the first carrier frequency or a second carrier frequency different than the first carrier frequency. In some implementations, the UE, the processor, and the method may further be configured to, capable of, or operable to generate the sequence based on a Zadoff-chu sequence, m-sequence, gold sequence, or Golay sequence.

In some implementations, the UE, the processor, and the method may further be configured to, capable of, or operable to receive, after receiving the sequence and according to a predetermined time domain offset, the at least one SSB in the first carrier frequency. In some implementations, the at least one SSB includes one or more SSB bursts, each SSB burst including two or more SSBs.

In some implementations, the UE, the processor, and the method may further be configured to, capable of, or operable to receive the sequence in a first subset of a set of consecutive symbols and receive the at least one SSB in a second subset of the set of consecutive symbols, where the first subset of the set of consecutive symbols is before the second subset of the set of consecutive symbols in a time domain.

In some implementations, the UE, the processor, and the method may further be configured to, capable of, or operable to receive a master information block (MIB), calculate a first part of the ID based on the PSS and the SSS of the at least one SSB, and calculate a second part of the ID based on the MIB. In some implementations, the first part of the ID includes a most significant bit (MSB) of the ID and the second part includes a least significant bit (LSB) of the ID or the first part of the ID includes the LSB of the ID and the second part includes the MSB of the ID.

In some implementations, the UE, the processor, and the method may further be configured to, capable of, or operable to receive the sequence from multiple transmission-reception points (TRPs), receive the at least one SSB from a single TRP, determine a TRP cluster ID associated with the multiple TRPs based on the sequence, and determine a TRP-specific ID associated with the single TRP based on the at least one SSB.

An NE (e.g., a base station) for wireless communication is described. The NE may be configured to, capable of, or operable to perform one or more operations as described herein. For example, the NE may be configured to, capable of, or operable to transmit a sequence indicating a presence of at least one SSB in a first carrier frequency and transmit the at least one SSB in the first carrier frequency based on the sequence.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a sequence indicating a presence of at least one SSB in a first carrier frequency and transmit the at least one SSB in the first carrier frequency based on the sequence.

A method performed or performable by an NE (e.g., a base station) for wireless communication is described. The method may include transmitting a sequence indicating a presence of at least one SSB in a first carrier frequency and transmitting the at least one SSB in the first carrier frequency based on the sequence.

In some implementations, the NE, the processor, and the method may further be configured to, capable of, or operable to transmit the sequence in the first carrier frequency or a second carrier frequency different than the first carrier frequency. In some implementations, the NE, the processor, and the method may further be configured to, capable of, or operable to generate the sequence based on a Zadoff-chu sequence, m-sequence, gold sequence, or Golay sequence.

In some implementations, the NE, the processor, and the method may further be configured to, capable of, or operable to transmit, after transmitting the sequence and according to a predetermined time domain offset, the at least one SSB in the first carrier frequency. In some implementations, where the at least one SSB includes one or more SSB bursts, each SSB burst including two or more SSBs.

In some implementations, the NE, the processor, and the method may further be configured to, capable of, or operable to transmit the sequence in a first subset of a set of consecutive symbols and transmit the at least one SSB in a second subset of the set of consecutive symbols, where the first subset of the set of consecutive symbols is before the second subset of the set of consecutive symbols in a time domain.

In some implementations, the NE, the processor, and the method may further be configured to, capable of, or operable to transmit the at least one SSB further indicating a first part of an ID associated with the NE and transmit a MIB indicating a second part of the ID. In some implementations, the first part of the ID includes an MSB of the ID and the second part includes a LSB of the ID or the first part of the ID includes the LSB of the ID and the second part includes the MSB of the ID.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of an initial cell search procedure in accordance with aspects of the present disclosure.

FIGS. 4A and 4B illustrate examples of an SSB in accordance with aspects of the present disclosure.

FIG. 5 illustrates an example of an initial cell search procedure in accordance with aspects of the present disclosure.

FIG. 6 illustrates an example of a process flow in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates an example of a flowchart of a method performed by a UE in accordance with aspects of the present disclosure.

FIG. 11 illustrates an example of a flowchart of a method performed by an NE in accordance with aspects of the present disclosure.

### DETAILED DESCRIPTION

An NE of a wireless communications system may broadcast one or more SSBs such that a UE of the wireless communications system may recognize the NE and synchronize to the NE. In some examples, the NE may transmit the one or more SSB with a default periodicity of 20 milliseconds (ms). In other examples, the NE may transmit the one or more SSBs with a relaxed periodicity (e.g., 160 ms). Increasing the periodicity of the one or more SSBs in such a way may increase computational complexity and memory at the UE. Specifically, increasing the periodicity may increase an amount of time that the UE searches for the one or more SSBs, or more specifically, PSSs of the one or more SSBs. The UE may monitor for SSBs in every symbol for a duration specified by the periodicity and every sync raster point in a specified frequency range.

The techniques described herein aim to reduce computational complexity at the UE caused by transmission of SSBs at a relaxed periodicity (e.g., 160 ms). In some examples, a UE may receive a sequence from the NE. The sequence may be known to the UE and indicate a presence of at least one SSB in a first carrier frequency (or a first sync raster point). Upon receiving the sequence, the UE may monitor the first carrier frequency for one or more SSBs and receive the one or more SSBs in the first carrier frequency or the second carrier frequency based on the monitoring. The one or more SSBs may each include a PSS and an SSS. The UE may use the PSS and the SSS to calculate (or generate) an ID associated with the NE. Searching for the sequence as opposed to the PSS may reduce computational complexity at the UE because the sequence is known to the UE.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides reduced computational complexity at the UE.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

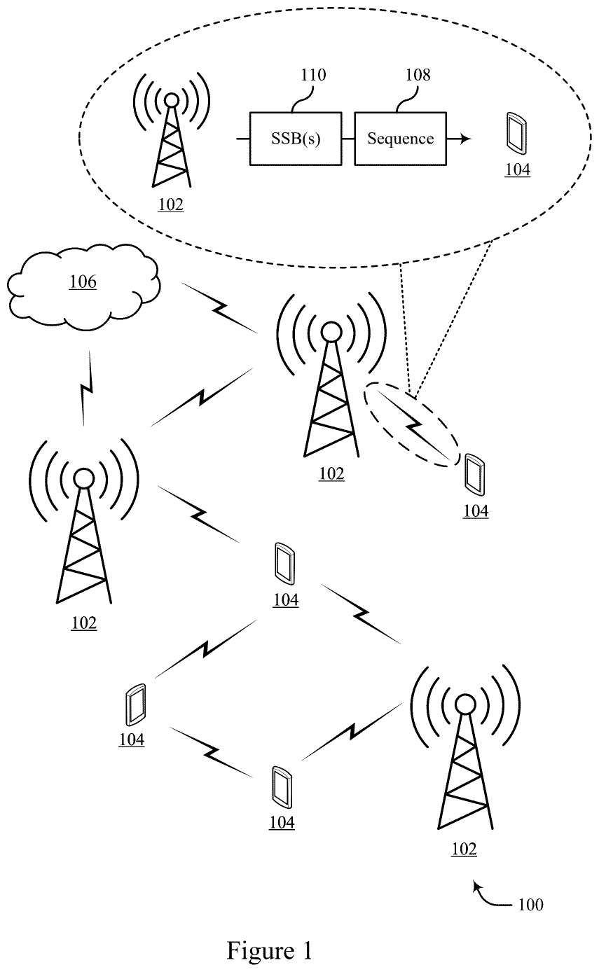

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support synchronization signals (SSs). For example, the NE 102 may periodically transmit a set of SSs carried in an SSB which may enable the UE 104 to recognize the NE 102 and synchronize to the NE 102. A singular SSB may span 4 OFDM symbols in a time domain and a maximum of 240 subcarriers in a frequency domain. A first OFDM symbol of the SSB may include a PSS and a third OFDM symbol of the SSB may include an SSS. The PSS and the SSS may span 127 subcarriers in the frequency domain. A second OFDM symbol, the third OFDM symbol, and a fourth OFDM symbol of the SSB may include a physical broadcast channel (PBCH). The PBCH may carry a minimum amount of system information (e.g., an indication of where remaining system broadcast information is transmitted). The NE 102 may transmit SSBs on a synchronization raster according to a default periodicity of 20 ms. The synchronization raster may define a set of allowed center frequencies (or sync raster points) from which the UE 104 searches for an SSB or more specifically, a PSS of the SSB.

Using the PSS and the SSS of the SSB, the UE 104 may determine a physical cell identity (PCI) of the NE 102 among 1008 unique PCI values. The PCI may be defined by Equation 1, where

$${N}_{ID}^{( 1 )} ∈ \{ 0 , 1 , … , 335 \}$$

$$and$$

$${N}_{ID}^{( 2 )} = ∈ \{ 0 , 1 , 2 \} .$$

$${N}_{ID}^{cell} = 3 {N}_{ID}^{( 1 )} + {N}_{ID}^{( 2 )} \qquad ( 1 )$$

The UE 104 may detect the PSS to acquire a symbol boundary and a course frequency synchronization. There may be 3 different PSSs denoted by dₚₛₛ. The 3 different PSSs are cyclic shifts of an m-sequence with length 127 generated according to Equations 2, 3, and

$$( n + 43 {N}_{ID}^{( 2 )} ) mod 127 and 0 \leq n \leq 127.$$

dₚₛₛ[n]=1−2x[m] (2)

x[i+7]=(x(i+4)+x(i))mod 2 (3)

[x(6)x(5)x(4)x(3)x(2)x(1)x(0)]=[1110110] (4)

The UE 104 may detect the SSS using the PSS. The SSS may include a Gold sequence of length 127 and two m-sequences, a first m-sequence with 9 cyclic shifts (m₀) and a second m-sequence with 112 cyclic shifts (m₁). The SSS may be generated according to Equation 5, where

$${m}_{0} = 15 [ \frac{{N}_{ID} ( 1 )}{112} ] + 5 {N}_{ID}^{( 2 )} , \qquad ( 5 )$$

$${m}_{1} = {N}_{ID}^{( 1 )} mod 112 ,$$

$$0 \leq n \leq 1 \; 27 ,$$

$${x}_{0} ( i + 7 ) = ( {x}_{0} ( i + 4 ) + {x}_{0} ( i ) ) mod 2 ,$$

$${x}_{1} ( i + 7 ) = ( {x}_{1} ( i + 1 ) + {x}_{1} ( i ) ) mod 2 ,$$

$$[ {x}_{0} ( 6 ) {x}_{0} ( 5 ) {x}_{0} ( 4 ) {x}_{0} ( 3 ) {x}_{0} ( 2 ) {x}_{0} ( 1 ) {x}_{0} ( 0 ) ] = [ 0000001 ] ,$$

$$and$$

$$[ {x}_{1} ( 6 ) {x}_{1} ( 5 ) {x}_{1} ( 4 ) {x}_{1} ( 3 ) {x}_{1} ( 2 ) {x}_{1} ( 1 ) {x}_{1} ( 0 ) ] = [ 0000001 ] .$$

$${d}_{sss} [ n ] = [ 1 - 2 {x}_{0} [ ( n + {m}_{0} ) mod 127 ] ] [ 1 - 2 {x}_{1} [ ( n + {m}_{1} ) mod 127 ] ]$$

336 different SSS sequences and 3 different PSS sequences may result in 1008 unique PCIs. The m-sequence is uncorrelated with its shifted version and has autocorrelation and low cross-correlation between two different cyclic shifts of an m-sequence as shown in Equation 6, where F_{g}=127 (number of SSS and PSS subcarriers).

$${R}_{dd} [ k ] = {\sum }_{n = 0}^{{F}_{sss} - 1} {d}_{g} [ n ] {d}_{g}^{*} [ n - k ] = \{ \begin{matrix}1 , & k = 0 , \\ \frac{- 1}{{F}_{g}} , & k \neq 0 ,\end{matrix} g ∈ \{ SSS , PSS \} \qquad ( 6 )$$

The UE 104 may compute a correlation between the received signal and each possible PSS sequence using this property of the m-sequence and determine

$${N}_{ID}^{( 2 )} ∈ \{ 0 , 1 , 2 \} .$$

This reduces the PCI search to 336 values. Using the PSS timing, the UE 104 may extract the SSS. As a result of generating the 336 SSS sequences and computing the correlations in Equation 6, the UE 104 may determine a highest correlation value and select

$${N}_{ID}^{( 1 )}$$

and thus, determine the PCI (e.g., using Equation 1).

The wireless communications system 100 may further support beam sweeping. In some examples, the NE 102 may transmit multiple SSBs using multiple directional beams. For example, the NE 102 may transmit a first SSB corresponding to a first SSB index using a first directional transmit beam and a second SSB corresponding to a second SSB index using a second directional transmit beam. Transmission of the multiple SSBs using multiple directional beams may be known as an SS burst. Each SS burst may be limited to 5 ms and have a default periodicity of 20 ms. The NE 102 may transmit the SSB burst in either a first half of a radio frame or a second half of the radio frame which is indicated in MIB.

In some examples, the NE 102 may transmit SSB(s) (e.g., a single SSB or an SSB burst) at a periodicity different than 20 ms. For example, the NE 102 may transmit the SSB(s) at a relaxed periodicity of 160 ms. Extending the SSB periodicity from 20 ms to 160 ms may increase computational complexity at the UE 104 because the UE 104 may search for the PSS in every symbol within the 160 ms duration and at different carrier frequencies (or sync raster points). Further, an initial frequency offset while doing initial cell synchronization may be high (e.g., +−10 PPM resulting in 70 kHz for a 7 GHz carrier frequency) resulting in the UE 104 performing more hypotheses on the frequency domain (e.g., −60, −30, 0, +30, and +60 for a 30 kHz SCS). Accordingly, techniques for reducing computation complexity at the UE 104 for SSBs having a relaxed periodicity are needed.

According to implementations, one or more of the NEs 102 and the UEs 104 are operable to implement various aspects of the techniques described with reference to the present disclosure. For example, a UE 104 receives a sequence 108 indicating a presence of at least one SSB 110 in a first carrier frequency, monitors for the at least one SSB 110 in the first carrier frequency based on the sequence 108, and generates an ID associated with an NE based on a PSS and an SSS of the at least one SSB. An NE 102 (e.g., a base station, gNB) transmits a sequence 108 indicating a presence of at least one SSB 110 in a first carrier frequency and transmits the at least one SSB 110 in the first carrier frequency based on the sequence 108.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

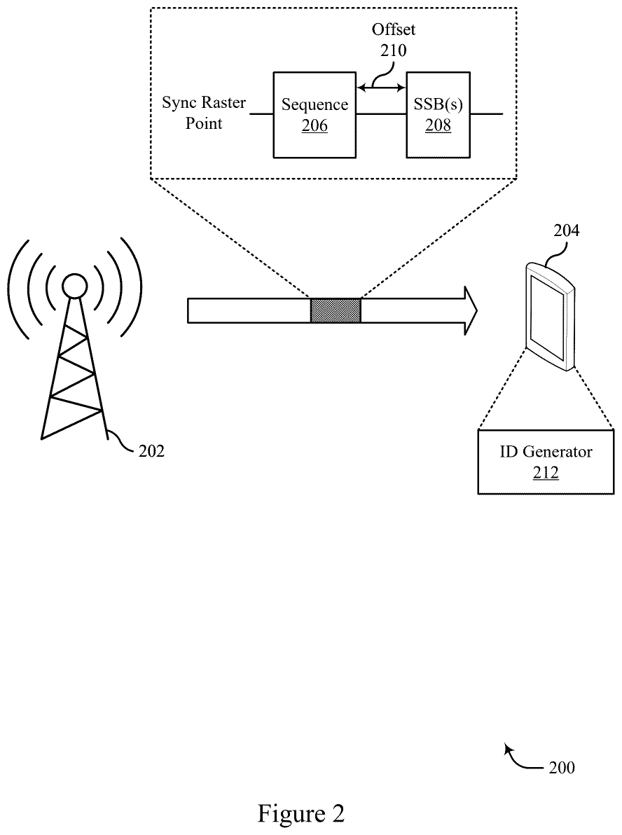

FIG. 2 illustrates an example of a wireless communications system 200 in accordance with aspects of the present disclosure. In some examples, the wireless communications system 200 may implement aspects of the wireless communications system 100. For example, the wireless communications system 200 may include an NE 202 and a UE 204 which may be examples of the NE 102 and the UE 104 as described with reference to FIG. 1, respectively.

The UE 204 may monitor a synchronization raster for one or more sequences 206 and receive a sequence 206 from the NE 202 in a first sync raster point (e.g., a first center frequency or a first carrier frequency) of the synchronization raster based on the monitoring. The UE 204 and the NE 202 may be preconfigured with the sequence 206. In other words, the UE 204 may have knowledge of the sequence 206 prior to receiving the sequence 206 from the NE 202. The sequence 206 may indicate a presence of one or more SSBs 208 in the synchronization raster. Specifically, the sequence 206 may indicate for the UE 204 to monitor the first sync raster point or a second sync raster point (e.g., a second center frequency or a second carrier frequency) of the synchronization raster for the one or more SSBs 208. Upon receiving the sequence 206, the UE 204 may monitor the first sync raster point or the second sync raster point for the one or more SSBs 208 and receive the one or more SSBs 208 from the NE 202 in the first sync raster point or the second sync raster point.

In some examples, the NE 202 and the UE 204 may be pre-configured with one or more of a duration, a frequency, a length, a periodicity, or an offset 210 associated with the sequence 206. The duration may specify a quantity of time resources (or symbols) occupied by the sequence 206, the offset 210 may specify a duration between the sequence 206 and the one or more SSBs 208, the frequency may indicate a quantity of frequency resources (e.g., quantity of resource elements (REs)) occupied by the sequence 206, the length may indicate a sequence length of the sequence 206, and the periodicity may indicate a time duration between each sequence 206. In some examples, the sequence 206 may occupy a same quantity of frequency resources as the PSS(s) or the SSS(s) of the one or more SSBs 208. For example, the sequence 206, the PSS(s), and the SSS(s) may occupy 127 subcarriers. Alternatively, the sequence 206 may occupy a different quantity of frequency resources than the PSS(s) or the SSS(s). Further, the periodicity associated with the sequence 206 may be the same or different than a periodicity associated with the one or more SSBs 208. For example, the periodicity associated with the sequence 206 and the periodicity associated with the one or more SSBs 208 may be 160 ms. Moreover, the sequence length associated with the sequence 206 may be the same or different than a sequence length associated with the PSS(s) or the SSS(s) of the one or more SSBs 208.

In some examples, the NE 202 may transmit the one or more SSBs 208 on-demand (e.g., not according to a periodicity). The NE 202 may select on-demand SSB transmission when the network load is low (e.g., less than a threshold) or zero. An upper layer wake-up signal (UL WUS) configuration to request the on-demand one or more SSBs may be pre-configured in a public lands mobile network (PLMN) for an area or the UL WUS configuration may be saved from prior acquisition. In some examples, the on-demand SSB transmission may include dense SSB transmission for a duration for time-frequency tracking for the UE 204.

The sequence 206 may be generated based on an m-sequence, a gold sequence, a Zadoff-chu sequence, or a Golay sequence with a known cyclic shift. If the sequence 206 is generated based on the m-sequence or the gold sequence, polynomials and cyclic shifts for the sequence 206 may be selected from preferred pairs (e.g., primitive polynomials that have low cross correlation). In some examples, the sequence 206 may be distinct from that of the PSS(s) and the SSS(s) of the one or more SSBs 208. Further, the sequence 206 may be orthogonal to the PSS(s) and the SSS(s).

In some examples, the NE 202 may transmit multiple sequences 206 using multiple directional beams. Such transmission may be known as a sequence burst. In such example, the one or more SSBs 208 whose presence is indicated by the sequence burst may include an SSB burst (or a sequence of SSBs transmitted using multiple directional beams). A quantity of directional beams used to transmit the sequence burst may be the same as a quantity of directional beams used to transmit the following SSB burst. In some examples, NE 202 may transmit the sequence burst in a first half of a radio frame and the following SSB burst in a second half of the radio frame.

Using an ID generator 212, the UE 204 may determine (or calculate or generate) an ID associated with the NE 202 (e.g., a PCI) based on a PSS and an SSS of an SSB 208 of the one or more SSBs 208. In some examples, the network may limit a quantity of candidate PSSs to 1 and set a quantity of candidate SSSs to 336 or higher. The UE 204 may detect the PSS and find

$${N}_{ID}^{( 2 )} ,$$

where

$${N}_{ID}^{( 2 )} = 0 .$$

The UE 204 may then detect the SSS using the PSS and find

$${N}_{ID}^{( 1 )} ,$$

where

$${N}_{ID}^{( 1 )} ∈ \{ 0 , 1 , … , 335 \} .$$

Next, the UE 204 may calculate a first part of the ID using Equation 7. In some examples, the NE 202 may transmit a second part (or a remaining part) of the ID to the UE 204 in a MIB payload. As an example, the UE 204 may calculate an MSB part of the ID using the PSS and the SSS and identify an LSB part of the ID using the MIB payload or vice versa.

$${N}_{ID}^{cell} = 1 \times {N}_{ID}^{( 1 )} + {N}_{ID}^{( 2 )} \qquad ( 7 )$$

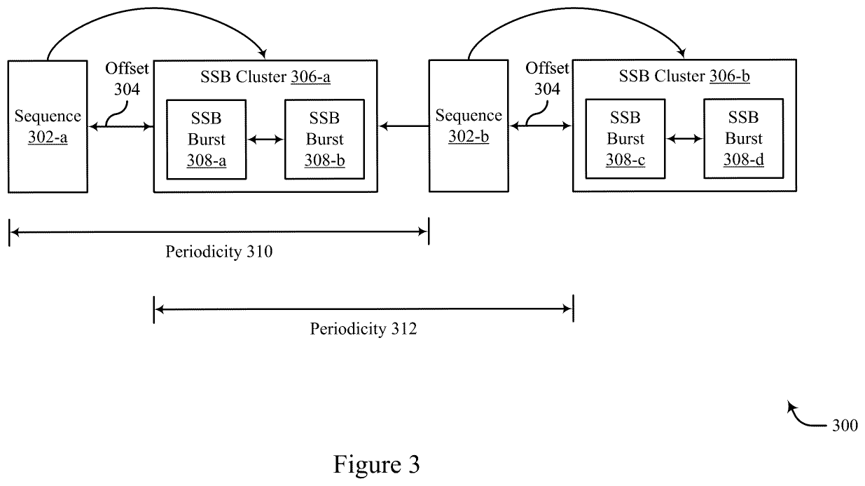

FIG. 3 illustrates an example of an initial cell search procedure 300 in accordance with aspects of the present disclosure. In some examples, the initial cell search procedure 300 may implement, or be implemented by, aspects of the wireless communications system 100 and the wireless communications system 200. For example, the initial cell search procedure may be performed by the NE 102, the UE 104, the NE 202, or the UE 204 as described with reference to FIGS. 1 and 2.

As described with reference to FIG. 2, a UE may receive a sequence from an NE in a synchronization raster that indicates a presence of one or more SSBs in the synchronization raster. Subsequently, the UE may monitor for and receive the one or more SSBs from the NE based on the sequence. In FIG. 3, the sequence may be an example of a sequence 302. The sequence 302 may indicate a presence of an SSB cluster 306 in the synchronization raster. As shown in FIG. 3, the NE may transmit a sequence 302-a to the UE that indicates a presence of an SSB cluster 306-a in the synchronization raster. Upon receiving the sequence 302-a, the UE may monitor the synchronization raster for the SSB cluster 306-a and receive the SSB cluster 306-a based on the monitoring. In some examples, the SSB cluster 306-a may include a quantity of SSB bursts 308. For example, the SSB cluster 306-a may include 2 SSB bursts 308 (e.g., an SSB burst 308-a and an SSB burst 308-b).

In some examples, the NE may transmit the sequence 302 according to a periodicity 310. For example, the NE may transmit a sequence 302-b after the sequence 302-a, where the sequence 302-a and the sequence 302-b are separated by a duration specified by the periodicity 310. In some examples, the periodicity 310 may be greater than 20 ms (e.g., a relaxed periodicity of 160 ms). The sequence 302-b may indicate a presence of an SSB cluster 306-b in the synchronization raster. Upon receiving the sequence 302-b, the UE may monitor the synchronization raster for the SSB cluster 306-b and receive the SSB cluster 306-b based on the monitoring. In some examples, the SSB cluster 306-b may include a quantity of SSB bursts 308. For example, the SSB cluster 306-b may include two SSB bursts 308 (e.g., an SSB burst 308-c and an SSB burst 308-d). Although FIG. 3 illustrates the SSB clusters 306 each including two SSB bursts 308, any other quantity of SSB bursts 308 may be possible (e.g., 3, 4, or 5 SSB bursts).

The NE may also transmit the SSB clusters 306 according to a periodicity 312. For example, the NE may transmit the SSB cluster 306-b after the SSB cluster 306-a, where the SSB cluster 306-a and the SSB cluster 306-b are separated by a duration specified by the periodicity 312. In some examples, the periodicity 312 may be the same or different than the periodicity 312. For example, the periodicity 310 and the periodicity 312 may be equal to 160 ms. Alternatively, the NE may not transmit the SSB clusters 306 according to the periodicity, but rather, the NE may transmit the SSB cluster 306 on-demand.

In some examples, the NE and the UE may be preconfigured with the sequence 302. That is, the sequence 302 may be known to both the NE and the UE prior to the initial cell search. In addition, the UE and the NE may be preconfigured with an offset 304 associated with the sequence 302. The offset 304 may specify a duration between the sequence 302 and a subsequent SSB cluster 306. The NE may transmit the sequence 302-a and the SSB cluster 306-a, where the sequence 302-a and the SSB cluster 306-a are separated from one another by the offset 304.

In some examples, the sequence 302 may be transmitted in a burst prior to each SSB cluster 306. For example, the NE may transmit repetitions of the sequence 302-a using multiple directional beams prior to the SSB cluster 306-a. In some examples, a quantity of directional beams used to transmit the sequence burst may be the same as a quantity of directional beams used to transmit the subsequent SSB cluster 306 indicated by the sequence burst. This may ensure that the coverage of the sequence 302 is similar to that of the corresponding SSB burst(s) 308.

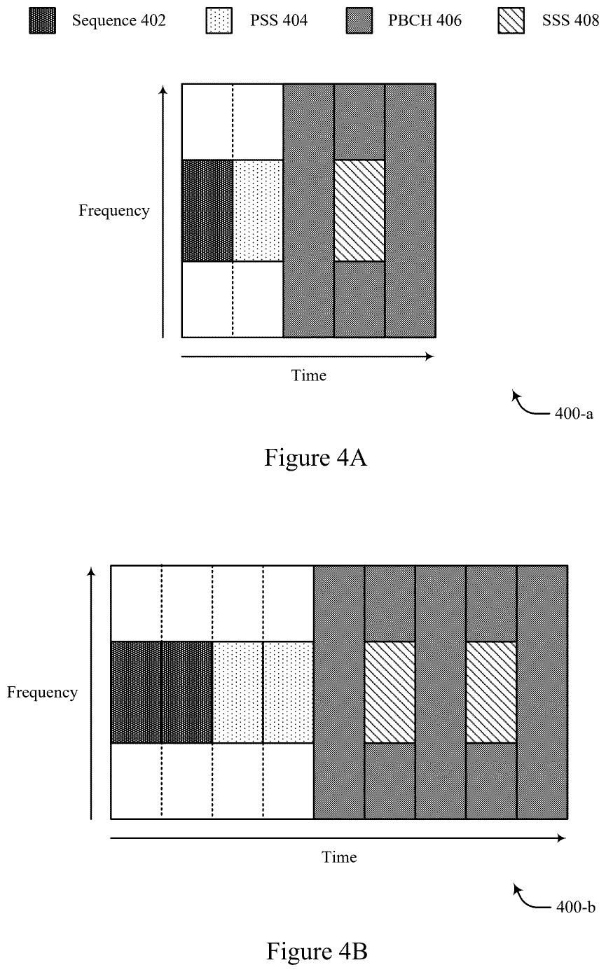

FIGS. 4A and 4B illustrate examples of an SSB 400 (e.g., an SSB 400-a and an SSB 400-b) in accordance with aspects of the present disclosure. In some examples, the SSB 400 may be implemented by aspects of the wireless communications system 100 and the wireless communications system 200. For example, the SSB may be implemented by the NE 102, the UE 104, the NE 202, or the UE 204 as described with reference to FIGS. 1 and 2.

As described in FIG. 2, a UE may receive a sequence from an NE that indicates a presence of one or more SSBs. Subsequently, the UE may monitor for and receive the one or more SSBs from the NE based on the sequence. In FIGS. 4A and 4B, the sequence may be an example of a sequence 402 which may be integrated in an SSB block structure.

In FIG. 4A, the SSB 400-a may span 5 symbols in a time domain and 240 subcarriers in a frequency domain. A first symbol of the SSB 400-a may carry the sequence 402. A second symbol of the symbol of the SSB 400-a may carry a PSS 404. A third symbol, a fourth symbol, and a fifth symbol of the SSB 400-a may carry a PBCH 406. The fourth symbol of the SSB 400-a may carry an SSS 408. The SSS 408 and the PSS 404 may span 127 subcarriers in the frequency domain. The sequence 402 may span a frequency that is the same or different than that of the SSS 408 and the PSS 404.

In FIG. 4B, the NE may repeat the sequence 402, the PSS 404, and the SSS 408 in the SSB 400-b. The SSB 400-b may span 9 symbols in a time domain and 240 subcarriers in a frequency domain. A first symbol of the SSB 400-b may carry a first repetition of the sequence 402 and a second symbol of the SSB 400-b may carry a second repetition of the sequence 402. A third symbol of the SSB 400-b may carry a first repetition of the PSS 404 and a fourth symbol of the SSB 400-b may carry a second repetition of the SSS 408. A fifth symbol, a sixth symbol, a seventh symbol, an eighth symbol, and a ninth symbol of the SSB 400-b may carry the PBCH 406. The sixth symbol of the SSB 400-b may carry a first repetition of the SSS 408 and the eighth symbol of the SSB 400-b may carry a second repetition of the SSS 408. Repeating the sequence 402, the PSS 404, and the SSS 408 within the SSB 400-b may increase reliability and coverage.

Although FIG. 4B illustrates the SSB 400-b including 2 repetitions of the sequence 402, the PSS 404, and the SSS 408, any quantity of repetitions of the sequence 402, the PSS 404, and the SSS 408 are possible. In some examples, a quantity of repetitions for each of the sequence 402, the PSS 404, and the SSS 408 may be independently configured (e.g., based on reliability and coverage requirements of the network). In other words, a quantity of symbols carrying each of the sequence 402, the PSS 404, and the SSS 408 may be different.

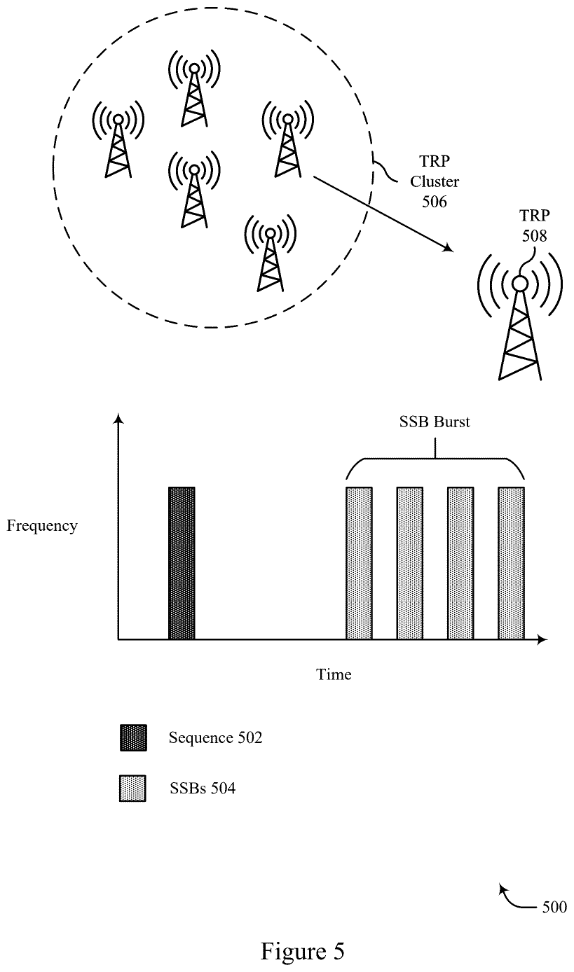

FIG. 5 illustrates an example of an initial cell search procedure 500 in accordance with aspects of the present disclosure. In some examples, the initial cell search procedure 500 may implement, or be implemented by, aspects of the wireless communications system 100 and the wireless communications system 200. For example, the initial cell search procedure may be performed by the NE 102, the UE 104, the NE 202, or the UE 204 as described with reference to FIGS. 1 and 2.

As described in FIG. 2, a UE may receive a sequence from an NE that indicates a presence of one or more SSBs. Subsequently, the UE may monitor for and receive the one or more SSBs from the NE based on the sequence. In FIG. 5, the sequence may be an example of a sequence 502.

In some examples, a wireless communications system may include a TRP cluster 506 that includes multiple TRPs (mTRP). The TRP cluster 506 may transmit the sequence 502 using single frequency network (SFN) over a single wide beam in a first sync raster point of a synchronization raster. The sequence 502 may indicate a presence of one or more SSBs 504 in the synchronization raster. Further, the sequence 502 may indicate an ID associated with the TRP cluster 506 (or a TRP cluster ID). In some examples, the TRP cluster 506 may transmit the sequence 502 with different cyclic shifts and each cyclic shift may be mapped to a respective TRP cluster ID. Thus, the UE may determine the TRP cluster ID based on a cyclic shift of the sequence 502.

Upon receiving the sequence 502, the UE may monitor the first raster point or a second raster point of the synchronization raster for the one or more SSBs 504 and receive the one or more SSBs 504 from a TRP 508 (or a single TRP (sTRP)) based on the monitoring. The one or more SSBs 504 may indicate an ID associated with the TRP 508 (or a TRP specific ID). Specifically, the UE may calculate the TRP specific ID using the SSS(s) and the PSS(s) of the one or more SSBs 504. In some examples, the one or more SSBs 504 may include an SSB burst.

In some examples, the TRP cluster 506 may transmit the sequence 502 according to first a periodicity. In some examples, the first periodicity may be greater than 20 ms (e.g., a relaxed periodicity of 160 ms). The TRP 508 may transmit the one or more SSBs 504 according to a second periodicity. In some examples, the second periodicity may be the same or different than the first periodicity. For example, the first periodicity and the second periodicity may be equal to 160 ms. Alternatively, the TRP 508 may not transmit the one or more SSBs 504 according to the second periodicity, but rather, the TRP 508 may transmit the one or more SSBs 504 on-demand.

In some examples, the TRP cluster 506 and the UE may be preconfigured with the sequence 502. That is, the sequence 502 may be known to both the TRP cluster 506 and the UE prior to the initial cell search procedure. In addition, the UE and the TRP cluster 506 may be preconfigured with an offset associated with the sequence 502. The offset may specify a duration between the sequence 502 and the subsequent one or more SSBs 504. The TRP cluster 506 may transmit the sequence 502 and the TRP 508 may transmit the one or more SSBs 504, where the sequence 502 and the one or more SSBs 504 are separated from one another by the offset. Thus, both of these transmissions are time-domain multiplexed (TDMed) with a predefined time gap. In some examples, the UE may utilize reference signal received power (RSRP) of the one or more SSBs 504 to determine an initial transmit power of a RACH preamble transmission.

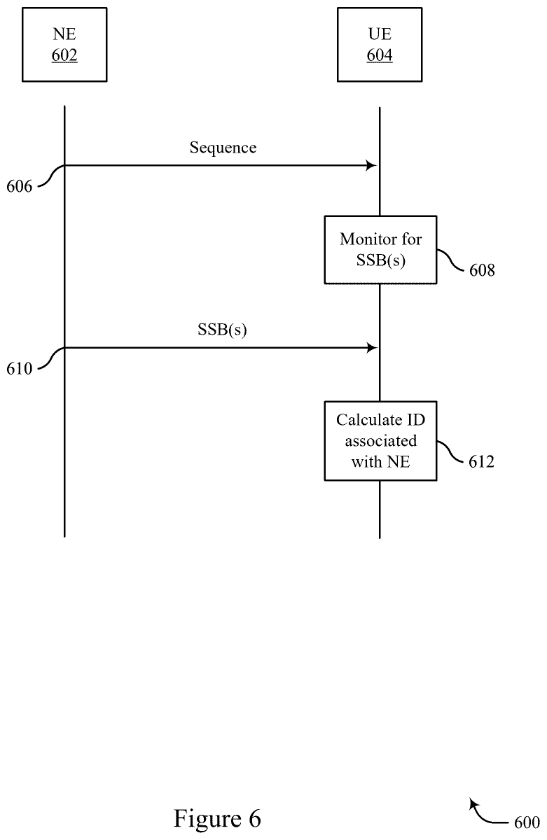

FIG. 6 illustrates an example of a process flow 600 in accordance with aspects of the present disclosure. In some examples, the process flow 600 may implement, or be implemented by, aspects of the wireless communications system 100 and the wireless communications system 200. For example, the process flow 600 may implement, or be implemented by, an NE 602 and a UE 604 which may be examples of the NE 102, the NE 202, the UE 104, or the UE 204 as described with reference to FIGS. 1 and 2.

At 606, the UE 604 may receive a sequence from the NE 602. The sequence may indicate a presence of at least one SSB in a first carrier frequency. In some examples, the UE 604 may receive the sequence in the first carrier frequency or a second carrier frequency different than the first carrier frequency. The UE 604 or the NE 602 may generate the sequence based on a Zadoff-chu sequence, an m-sequence, a gold sequence, or a Golay sequence. Further, the UE 604 may receive the sequence in a first subset of a set of consecutive symbols.

At 608, the UE 604 may monitor for the at least one SSB in the first carrier frequency based on the sequence. The at least one SSB may include a single SSB or one or more SSB bursts, each SSB burst including two or more SSBs.

At 610, the UE 604 may receive the at least one SSB from the NE 602 based on the monitoring. In some examples, the UE 604 may receive the at least one SSB after receiving the sequence and according to a predetermined time domain offset. In another example, the UE 604 may receive the at least one SSB in a second subset of the set of consecutive symbols. The first subset of the set of consecutive symbols may be before the second subset of the set of consecutive symbols in a time domain.

At 612, the UE 604 may generate an ID associated with the NE 602 based on a PSS and an SSS of the at least one SSB. In some examples, the UE 604 may calculate a first part of the ID based on the PSS and the SSS of the at least one SSB and calculate a second part (e.g., a remaining part) of the ID based on MIB. The first part of the ID may include MSBs of the ID and the second part of the ID may include LSBs of the ID or vice versa.

In some examples, the NE 602 may include mTRPs. In such case, the UE 604 may receive the sequence from the mTRPs and receive the at least one SSB from an sTRP included within the mTRPs. The UE 604 may determine a TRP cluster ID associated with the mTRPs based on the sequence and a TRP-specific ID associated with the sTRP based on the at least one SSB.

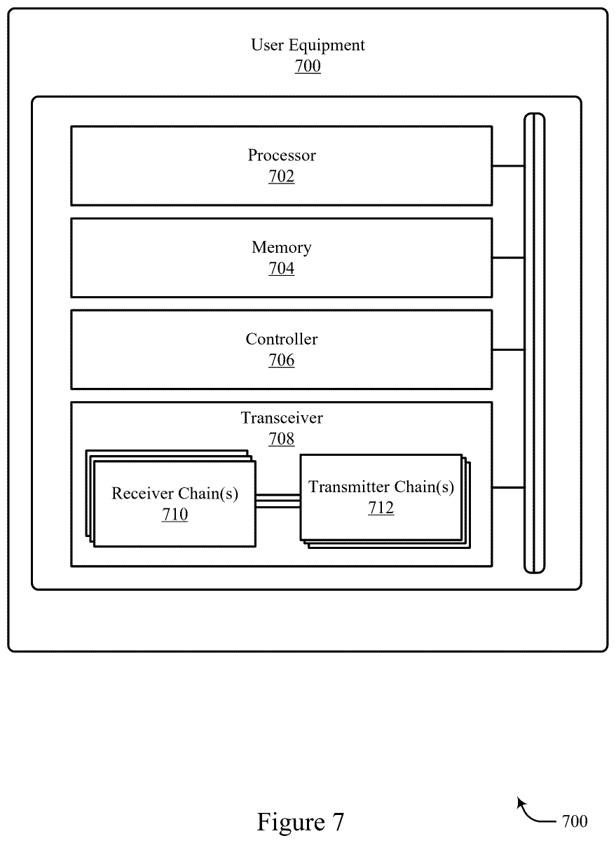

FIG. 7 illustrates an example of a UE 700 in accordance with aspects of the present disclosure. In some examples, the UE 700 may be an example of a UE as described with reference to FIGS. 1 through 6. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a sequence indicating a presence of at least one SSB in a first carrier frequency, monitoring for the at least one SSB in the first carrier frequency based on the sequence, and generating an ID associated with an NE based on a PSS and an SSS of the at least one SSB.

Additionally, or alternatively, the UE 700 may support at least one memory (e.g., the memory 704) and at least one processor (e.g., the processor 702) coupled with the at least one memory and configured to cause the UE to receive a sequence indicating a presence of at least one SSB in a first carrier frequency, monitor for the at least one SSB in the first carrier frequency based on the sequence, and generate an ID associated with an NE based on a PSS and an SSS of the at least one SSB.

Additionally, the UE 700 may be configured to support any one or combination of the at least one processor configured to cause the UE 700 to receive the sequence in the first carrier frequency or a second carrier frequency different than the first carrier frequency. Additionally, the UE 700 may be configured to support any one or combination of the at least one processor configured to cause the UE 700 to generate the sequence based on a Zadoff-chu sequence, m-sequence, gold sequence, or Golay sequence. Additionally, the UE 700 may be configured to support any one or combination of the at least one processor configured to cause the UE 700 to receive, after receiving the sequence and according to a predetermined time domain offset, the at least one SSB in the first carrier frequency.

Additionally, the UE 700 may be configured to support any one or combination of the at least one processor configured to cause the UE 700 to receive the sequence in a first subset of a set of consecutive symbols and receive the at least one SSB in a second subset of the set of consecutive symbols, where the first subset of the set of consecutive symbols is before the second subset of the set of consecutive symbols in a time domain. Additionally, the UE 700 may be configured to support any one or combination of the at least one processor configured to cause the UE 700 to receive a MIB, calculate a first part of the ID based on the PSS and the SSS of the at least one SSB, and calculate a second part of the ID based on the MIB.

Additionally, the UE 700 may be configured to support any one or combination of the at least one processor configured to cause the UE 700 to receive the sequence from multiple TRPs, receive the at least one SSB from a single TRP, determine a TRP cluster ID associated with the multiple TRPs based on the sequence, and determine a TRP-specific ID associated with the single TRP based on the at least one SSB.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

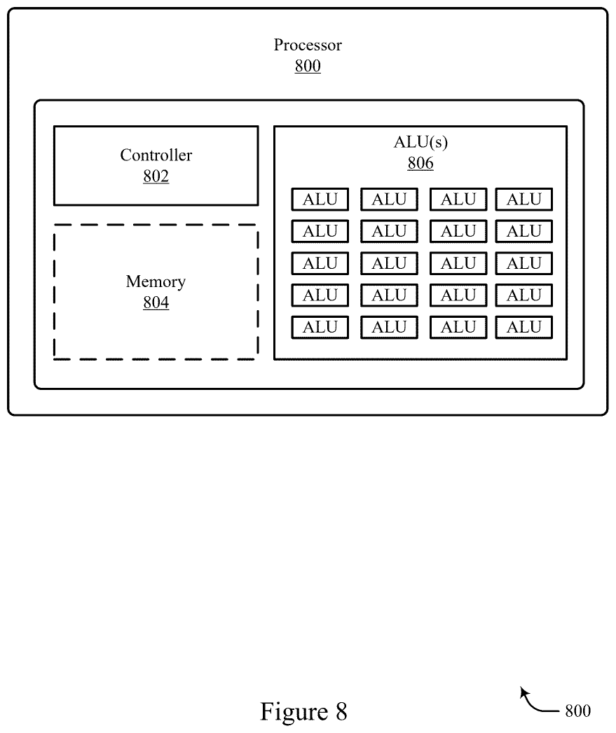

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive a sequence indicating a presence of at least one SSB in a first carrier frequency, monitor for the at least one SSB in the first carrier frequency based on the sequence, and generate an ID associated with a network equipment (NE) based on a PSS and an SSS of the at least one SSB.

Additionally, the processor 800 may be configured to or operable to support any one or combination of receiving the sequence in the first carrier frequency or a second carrier frequency different than the first carrier frequency. Additionally, the processor 800 may be configured to or operable to support any one or combination of generating the sequence based on a Zadoff-chu sequence, m-sequence, gold sequence, or Golay sequence. Additionally, the processor 800 may be configured to or operable to support any one or combination of receiving, after receiving the sequence and according to a predetermined time domain offset, the at least one SSB in the first carrier frequency.

Additionally, the processor 800 may be configured to or operable to support any one or combination of receiving the sequence in a first subset of a set of consecutive symbols and receiving the at least one SSB in a second subset of the set of consecutive symbols, where the first subset of the set of consecutive symbols is before the second subset of the set of consecutive symbols in a time domain. Additionally, the processor 800 may be configured to or operable to support any one or combination of receiving a MIB, calculating a first part of the ID based on the PSS and the SSS of the at least one SSB, and calculating a second part of the ID based on the MIB.

Additionally, the processor 800 may be configured to or operable to support any one or combination of receiving the sequence from multiple TRPs, receiving the at least one SSB from a single TRP, determining a TRP cluster ID associated with the multiple TRPs based on the sequence, and determining a TRP-specific ID associated with the single TRP based on the at least one SSB.

Moreover, the processor 800 may be configured to or operable to support at least one controller (e.g., the controller 802) coupled with at least one memory (e.g., the memory 804) and configured to cause the processor to transmit a sequence indicating a presence of at least one SSB in a first carrier frequency and transmit the at least one SSB in the first carrier frequency based on the sequence.

Additionally, the processor 800 may be configured to or operable to support any one or combination of transmitting the sequence in the first carrier frequency or a second carrier frequency different than the first carrier frequency. Additionally, the processor 800 may be configured to or operable to support any one or combination of generating the sequence based on a Zadoff-chu sequence, m-sequence, gold sequence, or Golay sequence. Additionally, the processor 800 may be configured to or operable to support any one or combination of transmitting, after transmitting the sequence and according to a predetermined time domain offset, the at least one SSB in the first carrier frequency.

Additionally, the processor 800 may be configured to or operable to support any one or combination of transmitting the sequence in a first subset of a set of consecutive symbols and transmitting the at least one SSB in a second subset of the set of consecutive symbols, where the first subset of the set of consecutive symbols is before the second subset of the set of consecutive symbols in a time domain. Additionally, the processor 800 may be configured to or operable to support any one or combination of transmitting the at least one SSB further indicating a first part of an ID associated with the NE and transmitting a MIB indicating a second part of the ID.

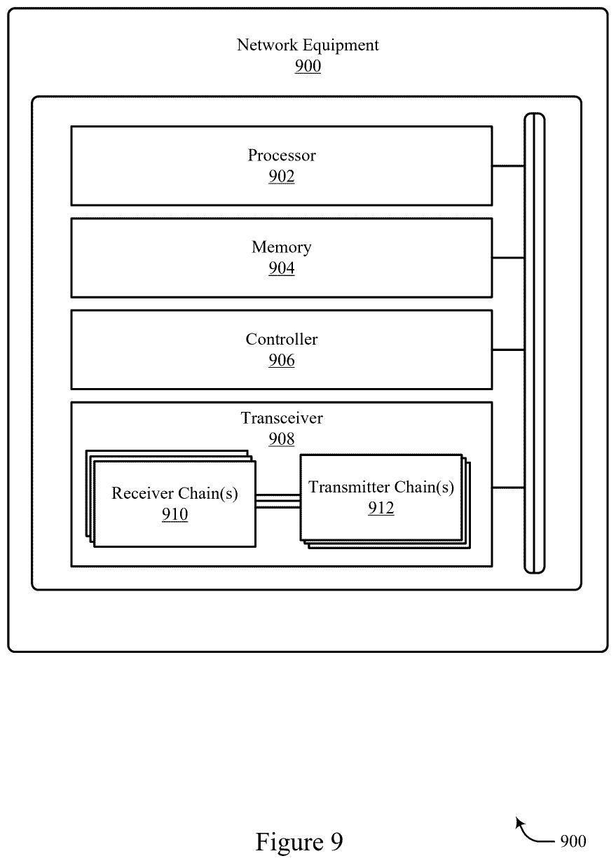

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting a sequence indicating a presence of at least one SSB in a first carrier frequency and transmitting the at least one SSB in the first carrier frequency based on the sequence.

Additionally, or alternatively, the NE 900 may support at least one memory (e.g., the memory 904) and at least one processor (e.g., the processor 902) coupled with the at least one memory and configured to cause the NE to transmit a sequence indicating a presence of at least one SSB in a first carrier frequency and transmit the at least one SSB in the first carrier frequency based on the sequence.

Additionally, the NE 900 may be configured to support any one or combination of the at least one processor configured to cause the NE 900 to transmit the sequence in the first carrier frequency or a second carrier frequency different than the first carrier frequency. Additionally, the NE 900 may be configured to support any one or combination of the at least one processor configured to cause the NE 900 to generate the sequence based on a Zadoff-chu sequence, m-sequence, gold sequence, or Golay sequence. Additionally, the NE 900 may be configured to support any one or combination of the at least one processor configured to cause the NE 900 to transmit, after transmitting the sequence and according to a predetermined time domain offset, the at least one SSB in the first carrier frequency.

Additionally, the NE 900 may be configured to support any one or combination of the at least one processor configured to cause the NE 900 to transmit the sequence in a first subset of a set of consecutive symbols and transmit the at least one SSB in a second subset of the set of consecutive symbols, where the first subset of the set of consecutive symbols is before the second subset of the set of consecutive symbols in a time domain. Additionally, the NE 900 may be configured to support any one or combination of the at least one processor configured to cause the NE 900 to transmit the at least one SSB further indicating a first part of an ID associated with the NE and transmit a MIB indicating a second part of the ID.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

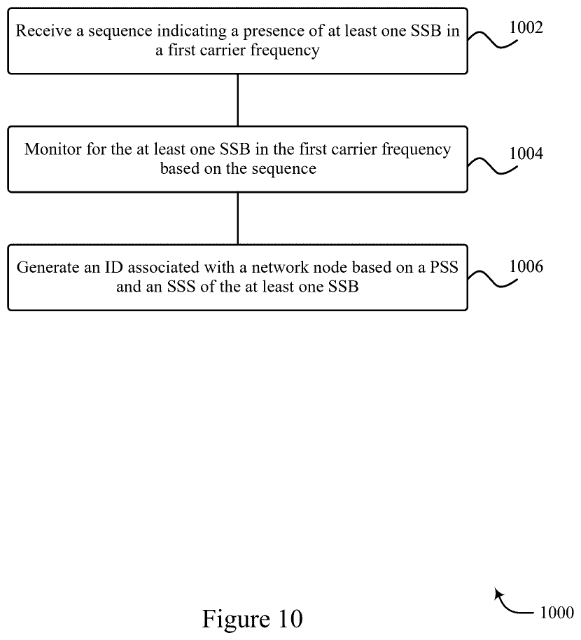

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving a sequence indicating a presence of at least one SSB in a first carrier frequency. The operations of 1002 may be performed in accordance with examples as described herein. In some implementations, aspects of the operations of 1002 may be performed by the UE 700 as described with reference to FIG. 7.

At 1004, the method may include monitoring for the at least one SSB in the first carrier frequency based on the sequence. The operations of 1004 may be performed in accordance with examples as described herein. In some implementations, aspects of the operations of 1004 may be performed by the UE 700 as described with reference to FIG. 7.

At 1006, the method may include generating an ID associated with an NE based on a PSS and an SSS of the SSB. The operations of 1006 may be performed in accordance with examples as described herein. In some implementations, aspects of the operations of 1006 may be performed the UE 700 as described with reference to FIG. 7.

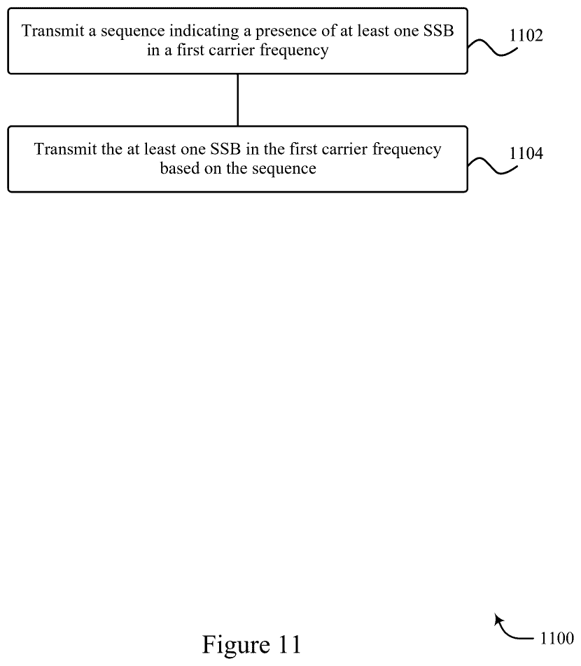

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a sequence indicating a presence of at least one SSB in a first carrier frequency. The operations of 1102 may be performed in accordance with examples as described herein. In some implementations, aspects of the operations of 1102 may be performed by the NE 900 as described with reference to FIG. 9.

At 1104, the method may include transmitting the at least one SSB in the first carrier frequency based on the sequence. The operations of 1104 may be performed in accordance with examples as described herein. In some implementations, aspects of the operations of 1104 may be performed by the NE 900 as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a sequence indicating a presence of at least one synchronization signal block (SSB) in a first carrier frequency;
monitor for the at least one SSB in the first carrier frequency based at least in part on the sequence; and
generate an identifier (ID) associated with a network equipment (NE) based at least in part on a primary synchronization signal (PSS) and a secondary synchronization signal (SSS) of the at least one SSB.

2. The UE of claim 1, wherein the at least one processor is operable to cause the UE to:
receive the sequence in the first carrier frequency or a second carrier frequency different than the first carrier frequency.

3. The UE of claim 1, wherein the at least one processor is operable to cause the UE to:
generate the sequence based at least in part on a Zadoff-chu sequence, m-sequence, gold sequence, or Golay sequence.

4. The UE of claim 1, wherein the at least one processor is operable to cause the UE to:
receive, after receiving the sequence and according to a predetermined time domain offset, the at least one SSB in the first carrier frequency.

5. The UE of claim 4, wherein the at least one SSB comprises one or more SSB bursts, each SSB burst comprising two or more SSBs.

6. The UE of claim 1, wherein the at least one processor is operable to cause the UE to:
receive the sequence in a first subset of a set of consecutive symbols; and
receive the at least one SSB in a second subset of the set of consecutive symbols, wherein the first subset of the set of consecutive symbols is before the second subset of the set of consecutive symbols in a time domain.

7. The UE of claim 1, wherein the at least one processor is operable to cause the UE to:
receive a master information block (MIB), and wherein, to generate the ID, the at least one processor is operable to cause the UE to:
calculate a first part of the ID based at least in part on the PSS and the SSS of the at least one SSB; and
calculate a second part of the ID based at least in part on the MIB.

8. The UE of claim 7, wherein:
the first part of the ID comprises a most significant bit (MSB) of the ID and the second part comprises a least significant bit (LSB) of the ID; or
the first part of the ID comprises the LSB of the ID and the second part comprises the MSB of the ID.

9. The UE of claim 1, wherein the at least one processor is operable to cause the UE to:
receive the sequence from multiple transmission-reception points (TRPs);
receive the at least one SSB from a single TRP;
determine a TRP cluster ID associated with the multiple TRPs based at least in part on the sequence; and
determine a TRP-specific ID associated with the single TRP based at least in part on the at least one SSB.

10. A network equipment (NE) for wireless communication, comprising:
at least one memory; and
at least one processor coupled with the at least one memory and operable to cause the NE to:
transmit a sequence indicating a presence of at least one synchronization signal block (SSB) in a first carrier frequency; and
transmit the at least one SSB in the first carrier frequency based at least in part on the sequence.

11. The NE of claim 10, wherein the at least one processor is operable to cause the NE to:
transmit the sequence in the first carrier frequency or a second carrier frequency different than the first carrier frequency.

12. The NE of claim 10, wherein the at least one processor is operable to cause the NE to:
generate the sequence based at least in part on a Zadoff-chu sequence, m-sequence, gold sequence, or Golay sequence.

13. The NE of claim 10, wherein the at least one processor is operable to cause the NE to:
transmit, after transmitting the sequence and according to a predetermined time domain offset, the at least one SSB in the first carrier frequency.

14. The NE of claim 13, wherein the at least one SSB comprises one or more SSB bursts, each SSB burst comprising two or more SSBs.

15. The NE of claim 10, wherein the at least one processor is operable to cause the NE to:
transmit the sequence in a first subset of a set of consecutive symbols; and
transmit the at least one SSB in a second subset of the set of consecutive symbols, wherein the first subset of the set of consecutive symbols is before the second subset of the set of consecutive symbols in a time domain.

16. The NE of claim 10, wherein the at least one processor is operable to cause the NE to:
transmit the at least one SSB further indicating a first part of an identifier (ID) associated with the NE; and
transmit a master information block (MIB) indicating a second part of the ID.

17. The NE of claim 16, wherein:
the first part of the ID comprises a most significant bit (MSB) of the ID and the second part comprises a least significant bit (LSB) of the ID; or
the first part of the ID comprises the LSB of the ID and the second part comprises the MSB of the ID.

18. A method performed by a user equipment (UE), the method comprising:
receiving a sequence indicating a presence of at least one synchronization signal block (SSB) in a first carrier frequency;
monitoring for the at least one SSB in the first carrier frequency based at least in part on the sequence; and
generating an identifier (ID) associated with a network equipment (NE) based at least in part on a primary synchronization signal (PSS) and a secondary synchronization signal (SSS) of the at least one SSB.

19. The method of claim 18, comprising:
receiving the sequence in the first carrier frequency or a second carrier frequency different than the first carrier frequency.

20. A method performed by a network equipment (NE), the method comprising:
transmitting a sequence indicating a presence of at least one synchronization signal block (SSB) in a first carrier frequency; and
transmitting the at least one SSB in the first carrier frequency based at least in part on the sequence.
